(19) United States
(12) Patent Application Publication
(10) Pub. No.: US 2006/0025003 A1
(43) Pub. Date: Feb. 2, 2006

(54) Phone plug structure with a locking function

(76) Inventor: Sheng-Hsin Liao, Shulin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/073,661

(22) Filed: Mar. 8, 2005

(30) Foreign Application Priority Data
Jul. 27, 2004 (TW) 93211890

(51) Int. Cl. H01R 13/625

(52) U.S. Cl. 439/344

(57) ABSTRACT

A phone plug structure with a locking function includes an insulative housing, a locking device, an interfered element and an extended wire. The insulative housing has a receiving space formed therein, and a retaining element disposed on an outside thereof. The locking device is received in the insulative housing. The interfered element connects with the locking device, wherein the interfered element is rotated and projected outside the insulative housing by the locking device to contact against the retaining element. The extended wire has one end connecting to the insulative housing. Whereby the phone plug structure has a locking device combined therein, so that the phone plug structure can not only transmit signal to an electronic apparatus, but can also be locked without needing another locking device.

### BACKGROUND OF THE INVENTION

1. Field of the Invention

The present invention relates to a phone plug structure with a locking function, and particularly relates to a phone plug structure having a lock combined therein.

2. Description of the Related Art

Referring to FIG. 1, a phone plug connects with a plurality of signal wires. The phone plug can be used to electrically connect between the signal wires and an electronic apparatus such as a computer. The phone plug has a casing 10a, a retaining element 11a with a retaining function disposed on an outside of the casing 10a, and a plurality of terminals 12a disposed inside the casing 10a. The terminals 12a can be moved a short distance longitudinally. A communication wire 20a is inserted into the casing 10a from a rear side of the casing 10a. The terminals 12a pierce into the communication wire 20a to electrically connect the terminals 12a and the communication wire 20a.

The phone plug can be inserted into a corresponding socket 30a. The socket 30a is installed onto the electronic apparatus such as a computer. Therefore, the terminals 12a of the phone plug electrically connect with terminals of the socket 30a to allow the transmitting of signals.

However, the phone plug is retained in the socket 30a by the retaining element 11a. Hence it is easy for anyone to separate the phone plug and the socket 30a, so the electronic apparatus is easily stolen. It is obvious that the phone plug lacks a locking function.

Referring to FIG. 2, in general a locking device 50a is installed on an electronic apparatus 40a such as a computer for obtaining a locking function. Hence, in order to obtain the locking function, a user not only needs to add the locking device 50a, but also the electronic apparatus 40a must be designed with a structure for connecting with the locking device 50a. Subsequently, the new structure will change the original structure of the electronic apparatus 40a.

### SUMMARY OF THE INVENTION

The present invention provides a phone plug structure with a locking function. The phone plug structure has a lock combined therein, so that the phone plug structure cannot only transmit signals to an electronic apparatus, but also has a locking function without using another locking device.

One aspect of the invention is a phone plug structure with a locking function. The phone plug structure includes an insulative housing, a locking device, an interfered element and an extended wire. The insulative housing has a receiving space formed therein, and a retaining element disposed on an outside thereof. The locking device is received in the insulative housing. The interfered element connects with the locking device, wherein the interfered element is rotated and projected outside the insulative housing to contact against the retaining element by the locking device. The extended wire has one end connected to the insulative housing.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objectives and advantages of the present invention will be more readily understood from the following detailed description when read in conjunction with the appended drawing, in which:

FIG. 1 is a perspective view of a phone plug and a phone socket of the prior art;

FIG. 2 is a perspective view of a lock installed on an electronic apparatus according to the prior art;

FIG. 3 is a perspective view of a phone plug according to the first embodiment of the prior art;

FIG. 4 is a cross-sectional view of a phone plug according to the first embodiment of the prior art;

FIG. 5 is a perspective view of a phone plug in use according to the first embodiment of the prior art;

FIG. 6 is a cross-sectional view of a phone plug in a locking state according to the first embodiment of the prior art;

FIG. 7 is a cross-sectional view of a phone plug according to the second embodiment of the prior art;

FIG. 8 is a perspective view of a phone plug according to the third embodiment of the prior art;

FIG. 9 is a cross-sectional view of a phone plug according to the fourth embodiment of the prior art;

FIG. 10 is a cross-sectional view of a phone plug in a locking state according to the fifth embodiment of the prior art;

FIG. 11 is a perspective view of a phone plug according to the sixth embodiment of the prior art;

FIG. 12 is a perspective view of a phone plug according to the seventh embodiment of the prior art;

FIG. 13 is a perspective view of a phone plug according to the eighth embodiment of the prior art;

FIG. 14 is a cross-sectional view of a phone plug in a locking state according to the ninth embodiment of the prior art; and

FIG. 15 is a cross-sectional view of a phone plug in a locking state according to the tenth embodiment of the prior art.

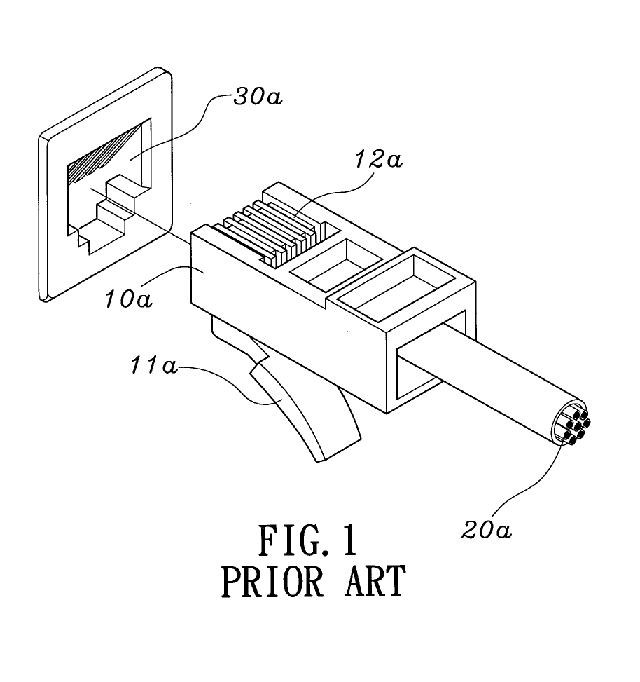

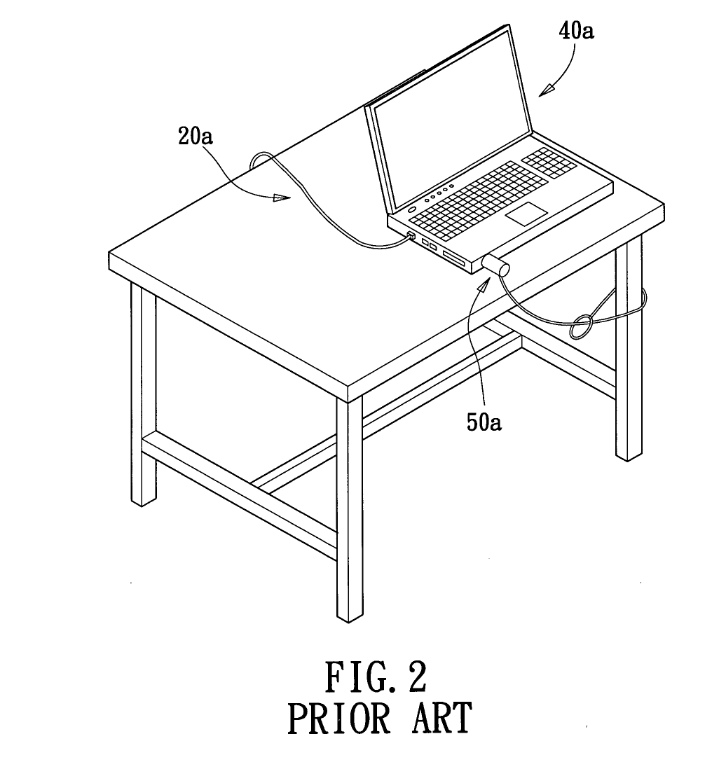

### DETAILED DESCRIPTION OF PREFERRED EMBODIMENTS

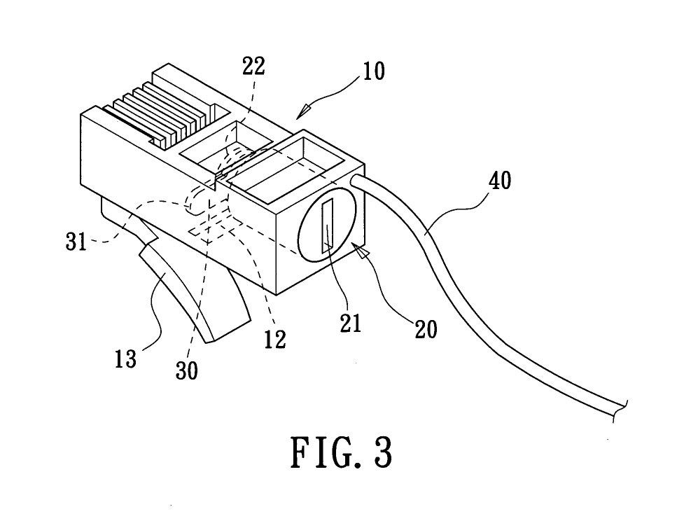

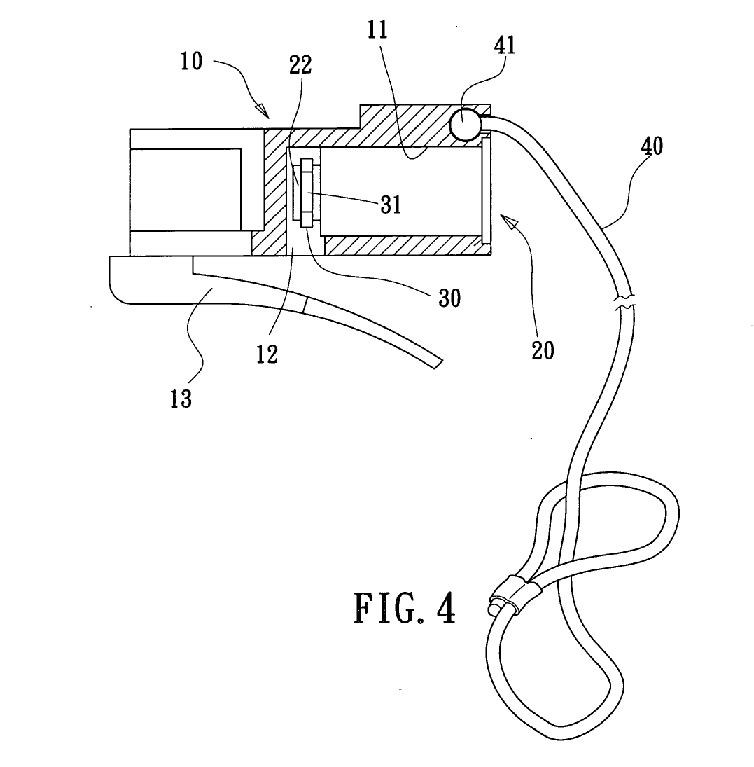

Referring to FIGS. 3 and 4, the present invention provides a phone plug structure with a locking function. The phone plug structure includes an insulative housing 10, a locking device 20, an interfered element 30 and an extension wire 40. The insulative housing 10 is made of insulating materials, such as plastic. The shape of the insulative housing 10 is approximately the same as the conventional insulative housing of the phone plug. The insulative housing 10 has a receiving space 11 formed therein for receiving the locking device 20. The insulative housing 10 further has a through hole 12 formed therein. The through hole 12 communicates with the receiving space 11. The through hole 12 is extended to an outer wall of the insulative housing 10. The insulative housing 10 has a retaining element 13 with a retaining function disposed on an outside thereof. The retaining element 13 has a predetermined length, so the retaining element has an elastic function.

The locking device 20 is a small-sized lock that can be rotated by a key. The locking device 20 has a keyhole 21 formed on one side thereof, and a rotating element 22 extended from another side thereof. The locking device 20 is fixed inside the receiving space 11 to connect with the insulative housing 10. The key is inserted into the keyhole 21 for rotating the rotating element 22.

The interfered element 30 connects with the rotating element 22, so that the interfered element 30 can be connected to the locking device. When the rotating element 22 is rotated by the key the rotating element 22 rotates the interfered element 30, so that a front side 31 of the interfered element 30 can be either projected outside the insulative housing 10 or returned to the inside of the insulative housing 10 by passing through the through hole 12. When the front side 31 of the interfered element 30 projects outside the insulative housing 10, the front side 31 contacts against an inner edge of the retaining element 13. The shape and the structure of the retaining element 13 do not limit the present invention.

The extended wire 40 has a predetermined length, and has a fixed side 41 formed on one side thereof. The fixed side 41 is fixed in the insulative housing 10.

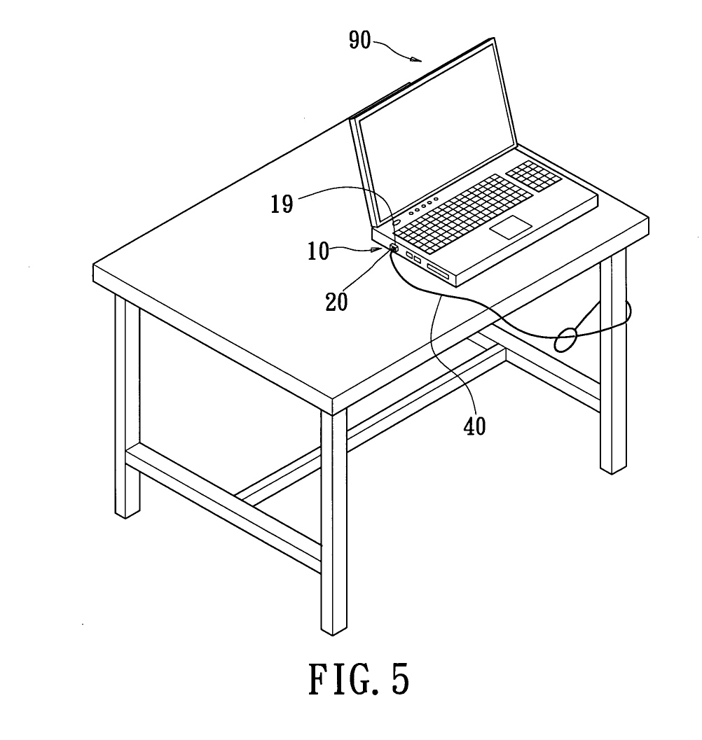

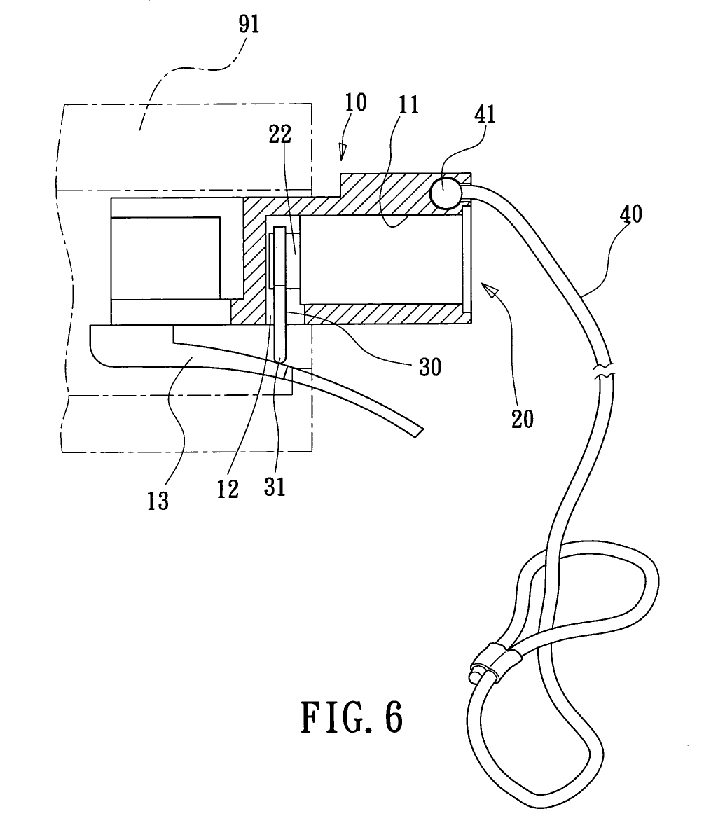

Referring to FIGS. 5 and 6, the other end of the extended wire 40 can be fixed around a fixed object, such as a leg of a desk. Then the insulative housing 10 can be inserted into a socket 91, and the retaining element 13 can be retained in the socket 91. The socket 91 is installed onto an electronic apparatus 90 such as a computer. Next the rotating element 22 of the locking device 20 is rotated by the key to rotate the interfered element 30, so that the front side 31 of the interfered element 30 projects outside the insulative housing 10, and contacts against the inner edge of the retaining element 13. Hence the retaining element 13 is embedded inside the socket 91 and cannot be pressed downward relative to the insulative housing 10, so that the phone plug structure cannot be separated from the electronic apparatus 90.

Acting on the same principle, the rotating element 22 of the locking device 20 is rotated again by the key to drive the interfered element 30, so that the front side 31 of the interfered element 30 returns to the inside of the insulative housing 10, and separates from the inner edge of the retaining element 13. Hence the retaining element 13 can be pressed downward relative to the insulative housing 10, and the phone plug structure can be separated from the electronic apparatus 90.

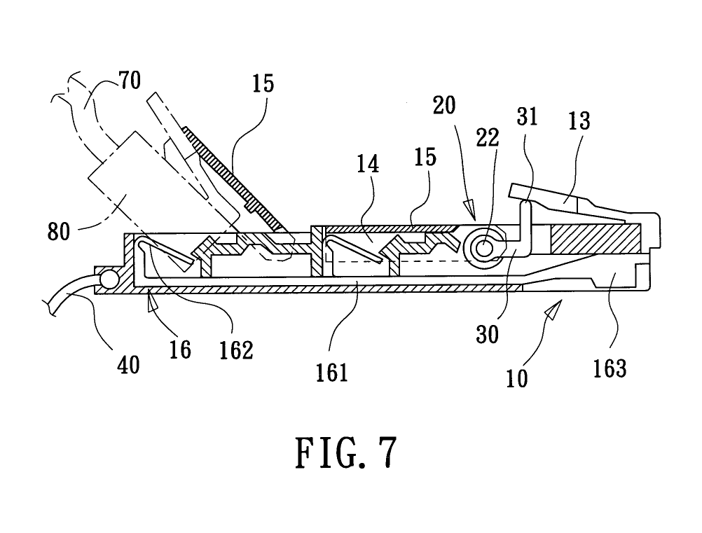

Referring to FIG. 7, the insulative housing 10 further includes more than one receiving groove 14, at least one cover 15 and a terminal set 16. The cover 15 can be movably pivoted on the insulative housing 10, and located at one side of the receiving groove 14. The cover 15 can be obliquely arranged on the insulative housing 10 or covered on the insulative housing 10. Hence a signal plug 80 with a communication wire 70 can be inserted into the receiving groove 14, and clamped between the cover 15 and the receiving groove 14.

The terminal set 16 is composed of a plurality of terminals 161, and assembled inside the insulative housing 10. The terminal 161 has a first contact potion 162 and a second contact portion 163. The first contact portion 162 is received in the receiving groove 14 of the insulative housing 10. The second contact portion 163 is located in a front side of the insulative housing 10. In the present embodiment, the cover 15 is firstly obliquely arranged on the insulative housing 10. Then the signal plug 80 is inserted between the cover 15 and the receiving groove 14. Next, the insulative housing 10 is inserted into a socket of an electronic apparatus for signal communication. Moreover, the rotating element 22 of the locking device 20 is rotated by the key to drive the interfered element 30, so that the front side 31 of the interfered element 30 projects outside the insulative housing 10, and contacts against the inner edge of the retaining element 13. Hence the retaining element 13 is embedded inside the socket and cannot be pressed downward relative to the insulative housing 10, so that the phone plug structure cannot be separated from the electronic apparatus.

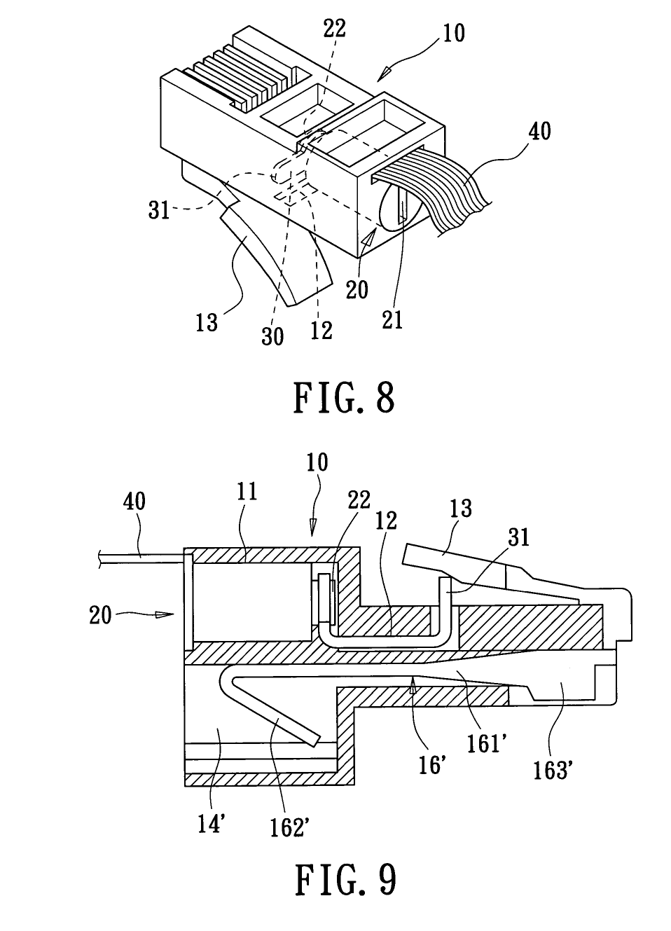

Referring to FIG. 8, the extended wire 40 can be flat shaped. One end of the extended wire 40 connects with the insulative housing 10 over the locking device 20.

Referring to FIG. 9, the insulative housing 10 has a terminal set 16′ composed of a plurality of terminals 161′. The terminal set 16′ is assembled inside the insulative housing 10. The terminal 161′ has a first contact potion 162′ and a second contact portion 163′. The first contact portion 162′ is received in the receiving groove 14′ of the insulative housing 10. The second contact portion 163′ is located in a front side of the insulative housing 10. In the present embodiment, a signal plug (not shown) is inserted into the receiving groove 14′. Next the insulative housing 10 is inserted into a socket of an electronic apparatus for signal communication.

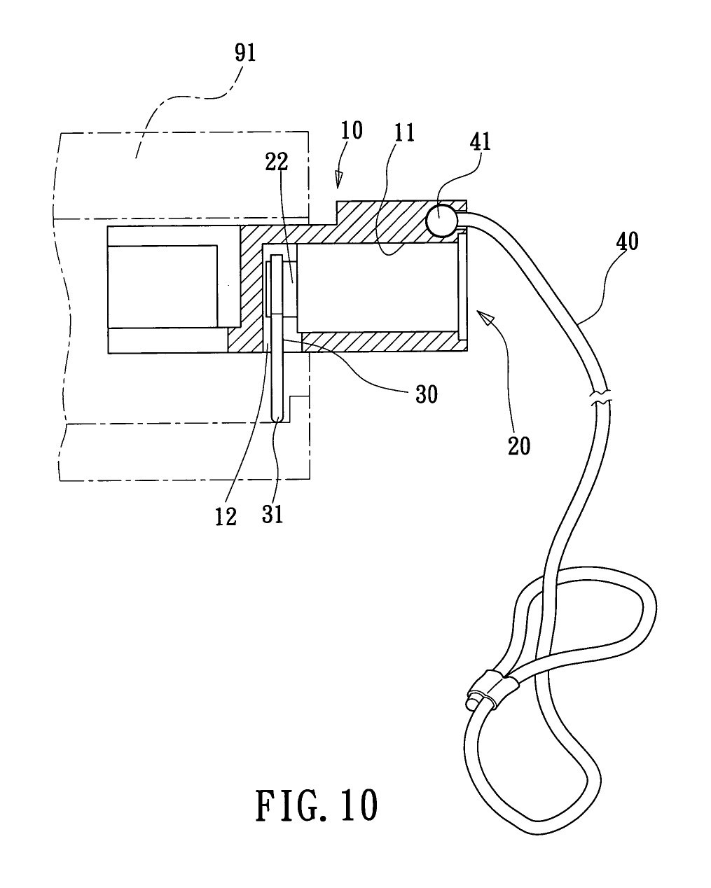

Referring to FIG. 10, the retaining element 13 can be omitted from the present invention. In other words, the retaining element 13 is not a vital component of the present invention. In the present embodiment, the rotating element 22 of the locking device 20 is rotated by the key to drive the interfered element 30, so that the front side 31 of the interfered element 30 projects outside the insulative housing 10, and contacts against an inner wall of a socket 91 of an electronic apparatus 90. Hence the phone plug structure cannot separate from the electronic apparatus 90.

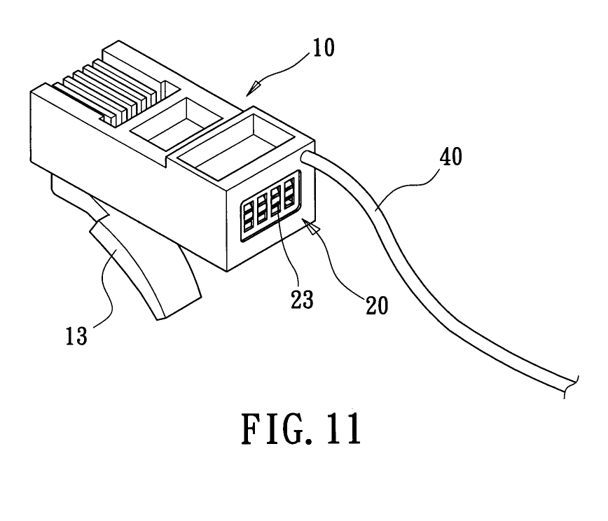

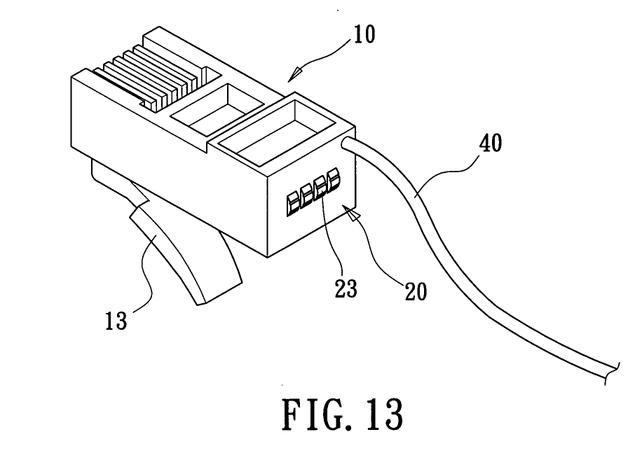

Referring to FIGS. 11 and 13, the locking element 20 can be a number lock. The locking element 20 has a number disk 23. When the number disk 23 is in the right place, the rotating element 22 of the locking device 20 can be rotated by a key to drive the interfered element 30, so that the front side 31 of the interfered element 30 projects outside the insulative housing 10, and contacts against the inner edge of the retaining element 13. Hence the retaining element 13 is embedded inside the socket and cannot be pressed downward relative to the insulative housing 10, so that the phone plug structure cannot separate from the electronic apparatus.

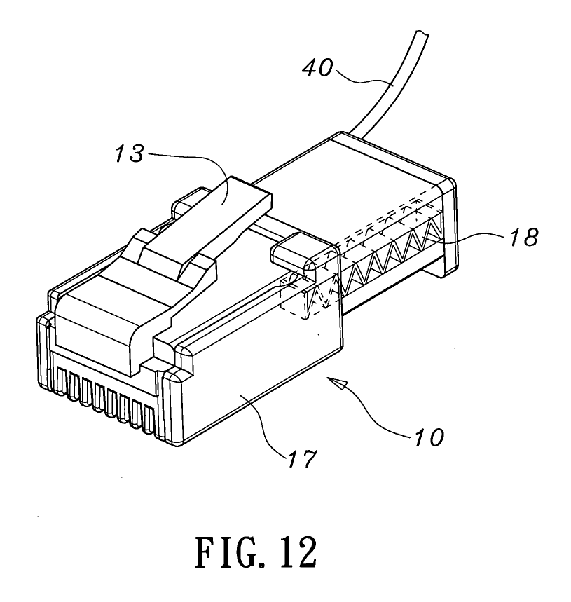

Referring to FIG. 12, an adapter 17 is assembled on the insulative housing 10. The adapter 17 can be moved forwards or backwards according to the requirements of the user. An elastic element 18 is assembled between the insulative housing 10 and the adapter 17.

When the phone plug structure is inserted into a small-scale socket, the adapter 17 must be moved backwards to a first position to reduce the front size of the phone plug structure. When the phone plug structure is inserted into a large-scale socket, the adapter 17 can be moved forwards to a second position due to the elasticity of the elastic element 18 to increase the front size of the phone plug structure.

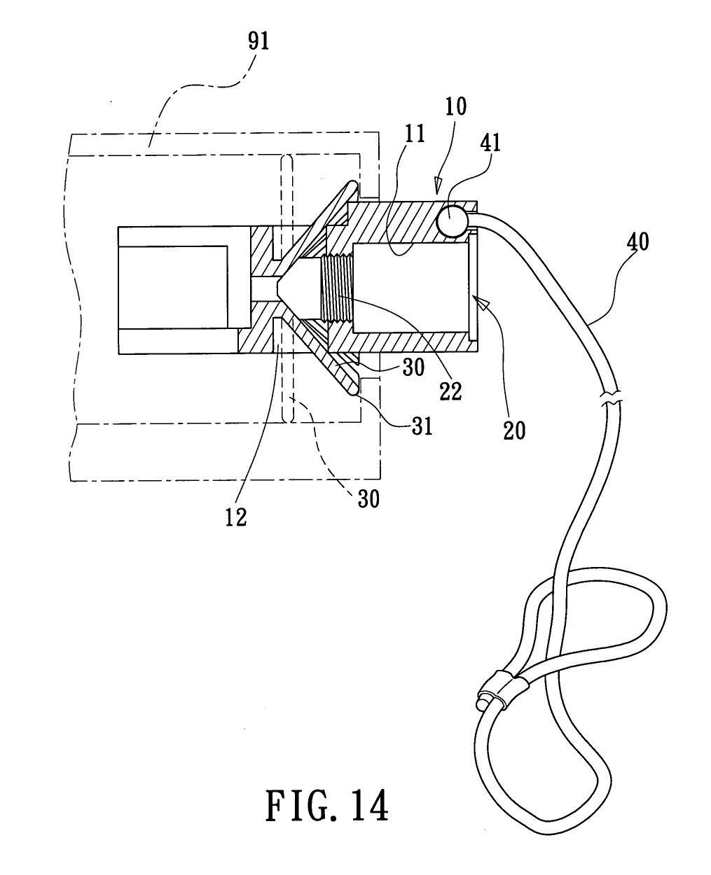

Referring to FIG. 14, the locking device 20 further includes an extension rotating element 22 with a taper. When the extension rotating element 22 is rotated to drive the interfered element 30 backwards or forwards by a key, the front side 31 of the interfered element 30 contacts against or separates from the inner wall of the insulative housing 10. Hence the phone plug structure can be locked in or separated from the electronic apparatus.

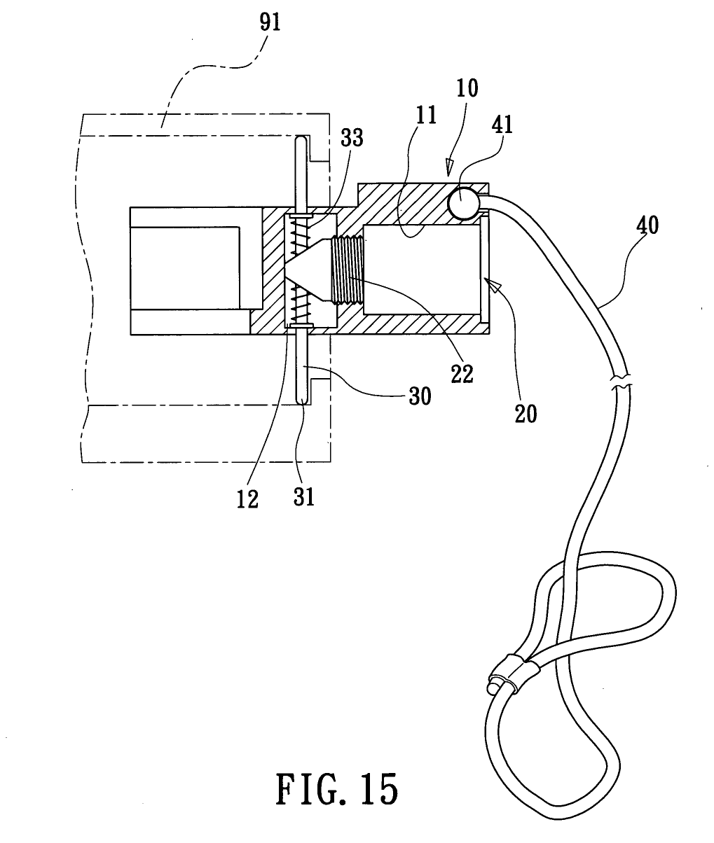

Referring to FIG. 15, the interfered element 30 is retained in the locking device 20 by a spring, and contacts an oblique side of the extension rotation 22. When the extension rotating element 22 is rotated to drive the interfered element 30 upwards or downwards by a key, the front side 31 of the interfered element 30 contacts against or separates from the inner wall of the insulative housing 10. Hence the phone plug structure can be locked in or separated from the electronic apparatus.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A phone plug structure with a locking function, comprising:
an insulative housing having a receiving space formed therein, and a retaining element disposed on an outside thereof;
a locking device received in the insulative housing;
an interfered element connecting with the locking device, wherein the interfered element is rotated and projected outside the insulative housing by the locking device to contact against the retaining element; and
an extended wire having one end connected to the insulative housing.

2. The phone plug structure as claimed in claim 1, wherein the insulative housing has a through hole communicating with the receiving space, and the through hole is extended to an outer wall of the insulative housing, wherein the interfered element projects outside the insulative housing by passing through the through hole.

3. The phone plug structure as claimed in claim 1, wherein the receiving space has an opening shaped for receiving the locking device.

4. The phone plug structure as claimed in claim 1, wherein the insulative housing is inserted into a socket of an electronic apparatus, and the retaining element is retained in the socket.

5. The phone plug structure as claimed in claim 1, wherein the locking device has a key hole formed on one side thereof and a rotating element arranged on an other side thereof, and the interfered element connects with the rotating element, wherein the rotating element is rotated by a key being entered into the key hole and rotated.

6. The phone plug structure as claimed in claim 1, wherein the extended wire has a fixed end fixed in the insulative housing.

7. The phone plug structure as claimed in claim 1, wherein the insulative housing has more than one receiving groove, and a terminal set composed of terminals and assembled therein, wherein the terminal has a first contact potion 162 received in the receiving groove, and a second contact portion 163 located in a front side of the insulative housing.

8. The phone plug structure as claimed in claim 7, wherein the insulative housing has a cover movably pivoted on the insulative housing, and located at one side of the receiving groove, wherein a signal plug is inserted between the cover and the receiving groove.

9. A phone plug structure with a locking function, comprising:
an insulative housing having a retaining element disposed on an outside thereof;
a locking device connecting with the insulative housing;
an interfered element connecting with the locking device, wherein the interfered element is rotated and projected outside the insulative housing by the locking device to contact against the retaining element; and
an extended wire connecting to the insulative housing.

10. The phone plug structure as claimed in claim 9, wherein the insulative housing has a through hole formed therein, and the through hole is extended to an outer wall of the insulative housing, wherein interfered element projects outside the insulative housing by passing through the through hole.

11. The phone plug structure as claimed in claim 9, wherein the insulative housing is inserted into a socket of an electronic apparatus, and the retaining element is retained in the socket.

12. The phone plug structure as claimed in claim 9, wherein the locking device has a key hole formed on one side thereof and a rotating element arranged on other side thereof, and the interfered element connects with the rotating element, wherein the rotating element is rotated by a key passing through the key hole and rotating.

13. The phone plug structure as claimed in claim 9, wherein the extended wire has a fixed end fixed in the insulative housing.

14. The phone plug structure as claimed in claim 9, wherein the insulative housing has more than one receiving groove, and a terminal set composed of terminals and assembled therein, wherein the terminal has a first contact potion 162 received in the receiving groove, and a second contact portion 163 located in a front side of the insulative housing.

15. The phone plug structure as claimed in claim 14, wherein the insulative housing has a cover movably pivoted on the insulative housing, and located at one side of the receiving groove, wherein a signal plug is inserted between the cover and the receiving groove.

16. The phone plug structure as claimed in claim 9, further comprising an adapter assembled on the insulative housing, and the adapter can be moved forwards or backwards according to the requirements of a user.

17. A phone plug structure with a locking function, comprising:
an insulative housing having a receiving space formed therein;
a locking device received in the insulative housing;
an interfered element connecting with the locking device, wherein the interfered element is rotated and projected outside the insulative housing by the locking device to contact against the retaining element; and
an extended wire having one end connecting to the insulative housing.
